(19) United States
(12) Patent Application Publication
(10) Pub. No.: US 2011/0244102 A1
(43) Pub. Date: Oct. 6, 2011

(54) Removal Of Reaction Byproducts And Impurities From Caramel Color And A Shelf Stable Caramel Color Concentrate

(75) Inventors: Setlur Ranganna Ramaswamy, Louisville, KY (US); Charles Walberg, Bronx, NY (US)

(73) Assignee: PepsiCo, Inc., Purchase, NY (US)

(21) Appl. No.: 13/053,307

(22) Filed: Mar. 22, 2011

Related U.S. Application Data
(60) Provisional application No. 61/318,836, filed on Mar. 30, 2010.

(51) Int. Cl. A23L 1/272; A23L 1/48

(52) U.S. Cl. 426/540; 426/495

(57) ABSTRACT

Caramel color concentrates are prepared by subjecting a solution of caramel color to ultrafiltration through a semi-permeable membrane having a Molecular Weight Cut Off (MWCA) of no greater than 3000 Daltons to retain caramel solids, but remove 4 MeI and other salts. After ultrafiltration, the retentate is subjected to an acidifying step to convert remaining impurities into salts which are then removed. A shelf stable concentrate is obtained having color bodies with a wide range of molecular weight.

This application claims priority to U.S. Provisional application No. 61/318,836 filed Mar. 30, 2010, the whole contents of which are incorporated herein by reference in its entirety.

### FIELD OF THE INVENTION

The invention relates to a process for removing 4-methyl imidazole (4 Met) a reaction byproduct from caramel color and further to a shelf stable liquid caramel color.

### BACKGROUND OF THE INVENTION

Caramel colors are food ingredients used to impart brown color of varying shade and intensity to a wide range of foods and beverages. By far, the largest use of caramel colors is in cola beverages. Significant amounts of caramel colors are also used in beer, bakery products, soy sauce, and distilled spirits.

Caramel colors are of different physical characteristics and composition. The soft drink caramel colors are made by reacting any acceptable food grade carbohydrate with ammonium sulfites. The brewery caramel colors are made by reacting carbohydrates with ammonia only. The caramel color used in high alcohol content distilled spirits is obtained by heating sugar with sodium hydroxide.

Caramel used in beverages to impart its brown color contains parts per million (ppm) quantities of 4-methyl imidazole (hereafter 4 Met) which need to be removed or at least drastically reduced. A particular problem with caramel color prepared in an ammonia process is the production of Ma It is believed that 4-MeI is a reaction product of the carbohydrates in combination with the ammonia catalyst used in the process. The Food and Drug Administration has limited the content of 4-MeI in caramel color.

One method of removing 4 MeI is through ultrafiltration such as described by U.S. Pat. No. 4,416,700, hereby incorporated by reference in its entirety. However, even though desired color bodies are retained on the membrane during the ultrafiltration process, many of the compounds that are small enough pass through the semi-permeable membrane along with the 4 MeI.

### BRIEF SUMMARY OF THE INVENTION

Aspects of the invention are directed to the removal of 4 MeI in caramel color by ultrafiltration using a semi-permeable membrane having a Molecular Weight Cut Off (MWCO) of 3000 Daltons or less. In one aspect the MWCO is about 250 Daltons.

In accordance with the 4 MeI removal process of the present invention, a starting solution containing caramel color solids (which may be diluted) is alkalized, typically with sodium or potassium hydroxide, to a pH of 6.5 to 8.5. This alkalized material is subjected to ultrafiltration using the above-noted MWCO membranes to remove the 4 MeI in the permeate (filtrate) and retain the color bodies and most of the solids from the starting solution on the membrane. This retained solution (retentate) is then acidified with an acid, typically phosphoric acid, sulfuric acid, sulfurous acid or hydrochloric acid, to a pH of not greater than 3, typically 2 to 3. Salts formed due to the addition of the acid are removed by further ultrafiltration. The resulting low pH acid retentate is the desired purified caramel color.

Additional aspects relate to purified shelf-stable caramel color concentrate having color body solids, wherein the solids have a range of molecular weights of about greater than about 150, typically 150 to greater than 30,000 Daltons, wherein at least 40% of the color bodies have a molecular weight range less than 10,000.

### DETAILED DESCRIPTION OF THE INVENTION

Caramel color is produced by caramelizing a carbohydrate solution to form high molecular weight color bodies. U.S. Pat. No. 4,614,662, for example, discloses a continuous process utilizing ammonia sulfites to produce caramel color. After the caramel color is produced, the solution is filtered using ultrafiltration to separate color bodies.

Ultrafiltration is a process to separate materials of relatively high molecular weight from those of lower molecular weight. The process typically encompasses placement of a solvent (e.g., water) solution containing the materials to be separated on one side (retentate side) of a semi-permeable membrane. The size of the membrane is selected so as to retain materials in the solution above a particular molecular weight but to allow the passage, with solvent, of those below a particular molecular weight. Hydrostatic or hydrokinetic pressure is applied to the solution, and continuous or periodic addition of solvent to the solution allows the ultrafiltration to continue for a time sufficient to reach a theoretically high degree of removal of permeable materials from the sample.

The ultrafiltration utilizes semi-permeable membranes which are defined by “molecular weight cut off” or MWCO. MWCO is the mass ratio of a molecule in reference to the hydrogen atom that is filtered out by the membrane. This ratio is referred to as Daltons. A unit of Dalton is defined as the mass of a hydrogen atom. The molecular weight scale is set up based on the ratio of mass of a given molecule to the mass of a hydrogen atom. So the mass of a molecule (molecular weight) M is M Daltons which is as heavy as M atoms of hydrogen. For example, glucose has a molecular weight of 180 so its molecular mass is 180 Daltons.

Historically, ultrafiltration of caramel solids solutions, such as disclosed in U.S. Pat. No. 4,614,662, utilized semi-permeable membranes having a MWCO of 10,000 to 30,000 Daltons (10-30 kDa) Such membranes allowed many of the low molecular weight, but desirable, color solids to be filtered out of caramel solution. Thus, such membranes retained only 20 to 30% of the caramel color solids making the purified material very viscous when concentrated to microbially stable % solids levels. That is, this purified fraction could not be constituted into a liquid material having greater than 25% solids because high viscosity and unacceptable handling properties. The resulting material can be like a stiff paste at room temperatures. For microbially stable caramel color about 50% solution of purified material is required.

The present invention is directed to an ultrafiltration process using a semi-permeable membrane having a MWCO of 3000 Daltons or smaller, for example, less than 2000 Daltons, less than 1000 Daltons, or less than 500 Daltons, and typically about 250 Daltons to retain a wide range of caramel solids, but also to remove 4 MeI and the salts formed during preparation of the caramel color solution. Notably, the MWCO of the membranes disclosed in U.S. Pat. No. 4,614,662 are 4 to 120 times larger than the MWCO of the membranes used in the present invention.

It was not expected that a semi-permeable membrane having a MWCO as low as, or lower than, 3000 Daltons or smaller such as 250 Daltons would have worked effectively. The object of the earlier work on caramel UF was designed to separate color bodies whose molecular weights are 10,000 Daltons or more hence high MWCO membranes were used and recovery of the caramel solids were low in the range of 25%. Further, there were issues of membrane plugging by large sized molecules.

The process of the present invention allows not only removal of greater than 97% of the MeI from the caramel solution but recovers most of (at least 50%) of the caramel's solids. Retention of a higher proportion of the caramel solids in the purified retentate makes the caramel's solids closer to the original material in both flow and stability characteristics. This result is partly due to the molecular weight range of the solids being wider than the molecular weight range obtained with prior membranes. The present invention traps most of the caramel's solids and provides a molecular weight range of at least about 150 to greater than 30,000 Daltons. Prior art membranes provided molecular weight distributions of at least about 10,000 Daltons and higher. The present process can yield a purified material containing about 80% original caramel's solids so that most of the material with molecular weight greater than 150 Daltons. It is this enhanced recovery of solids and their molecular weight distribution close to the original material that makes the resultant product useful.

The higher range of recovery of solids using the semi-permeable membranes having a MWCO of 3000 Daltons or less also reduces waste disposal problems. The permeate will have to be treated before disposal Since most of the solids of the starting caramel are captured in the purified material very little ends up in the effluent there by reducing greatly the disposal problem.

Aspects of the invention are therefore directed to a process for treating caramel color solutions by ultrafiltration for the purpose of preparing a shelf-stable liquid caramel color. The process is performed at conditions to increase the concentration of solids in the purified product but also to preserve and maintain all the desirable functional properties of the original caramel color.

A starting solution of caramel color is subjected to ultrafiltration through a semi-permeable membrane having a MWCO of 3000 Daltons or less to yield a permeated fraction passing through the membrane and a retained fraction or retentate, which does not pass through the membrane. The retentate contains high molecular weight color bodies, other non color material, and water. The starting caramel solution may be alkalized prior to ultrafiltration, typically with sodium or potassium hydroxide, to a pH between of 6.5 to 8.5. The temperature of the color body solution during ultrafiltration is between about 30 and 90° C.

The retentate is then acidified with any suitable acid, typically phosphoric acid, sulfuric acid, sulfurous acid, or hydrochloric acid, to a pH of not greater than 3, typically 2 to 3. The salts formed during the neutralization process are removed by further ultrafiltration to the desired level. This low pH acid retentate is the desired purified caramel color.

The process of this invention may be performed in a continuous, semi-continuous, or batch manner.

A shelf stable purified caramel color concentrate comprising color solids having a molecular weight distribution wherein the molecular weight is at least about 150, typically 150 to 30,000 and greater wherein at least 40% of the color bodies have a molecular weight range less than 10,000.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A process for removing 4-methyl imidazole (4-MeI) from a starting solution containing caramel color solids by ultrafiltration through a semi-permeable membrane having a MWCO of 3000 Daltons or less to yield a permeated fraction passing through the membrane and a retentate which does not pass through the membrane; wherein the retentate comprises at least 50% of the solids of the starting solution.

2. The process according to claim 1 wherein prior to ultrafiltration, an alkaline is added to the starting solution to raise the pH.

3. The process according to claim 2 wherein the pH of the starting solution is raised to 6.5 to 8.5.

4. The process according to claim 2 wherein the alkaline is sodium hydroxide or potassium hydroxide.

5. The process of claim 1 wherein the semi-permeable membrane has a MWCO of less than 2000 Da.

6. The process of claim 1 wherein the semi-permeable membrane has a MWCO of less than 1000 Da.

7. The process of claim 1 wherein the semi-permeable membrane has a MWCO of less than 500 Da.

8. The process of claim 1 wherein the semi-permeable membrane has a MWCO of 250 Da.

9. The process of claim 1 wherein the retentate comprises at least 60% solids of the starting caramel color solids.

10. The process of claim 1 further comprising adding an acid to the retentate to lower the pH and convert impurities in the retentate to salts and then removing the salts.

11. The process of claim 10 wherein the pH is lowered to not more than 3.

12. The process of claim 10 wherein the pH is lowered to 2 to 3.

13. The process of claim 10 wherein the acid is at least one selected from the group consisting of phosphoric acid, sulfuric acid, sulfurous acid, and hydrochloric acid.

14. The process according to claim 10 wherein the salts are removed by further ultrafiltration.

15. The process according to claim 1 wherein greater than 97% of the MeI is removed from the starting solution.

16. A shelf stable purified caramel color concentrate comprising color solids having a molecular weight distribution between 150 and 30,000, wherein at least 40% of the color bodies have a molecular weight range less than 10,000.

17. The shelf stable purified caramel color concentrate of claim 16 prepared by subjecting a starting solution containing caramel color solids to ultrafiltration through a semi-permeable membrane having a MWCO of 3000 Daltons or less to yield a permeated fraction passing through the membrane and a retentate which does not pass through the membrane; wherein the retentate comprises at least 50% solids of the starting caramel color solids.

18. The shelf stable purified caramel color concentrate of claim 17 further comprising adding an acid to the retentate to lower the pH and convert impurities in the retentate to salts and then removing the salts.
